(19) United States
(12) Patent Application Publication
(10) Pub. No.: US 2003/0179920 A1
(43) Pub. Date: Sep. 25, 2003

(54) Inspection system for determining object orientation and defects

(75) Inventors: Jeff Hooker, Melbourne, FL (US); Steve Simmons, Melbourne, FL (US)

Correspondence Address: RICHARD K. WARTHER, ALLEN, DYER,DOPPELT,MILBRATH & GILCHRIST P.A., 1401 CITRUS CENTER 255 SOUTH ORANGE AVENUE, P.O. BOX 3791, ORLANDO, FL, 32802-3791, US

(73) Assignee: INTELLIGENT MACHINE CONCEPTS, L.L.C.

(21) Appl. No.: 10/385,203

(22) Filed: Mar. 10, 2003

Related U.S. Application Data
(60) Provisional application No. 60/364,194, filed on Mar. 13, 2002.

(51) Int. Cl. G06K 9/00

(52) U.S. Cl. 382/141

(57) ABSTRACT

A system and method of the present invention inspects cylindrical, circular or spherical objects, such as cans. A camera acquires images of a reference object and objects to be inspected. A reference object is rotated and imaged by at least one camera. A processor is operatively connected to the at least one camera and object rotator and draws a position mask based on images of the reference object in rotated positions to create a reference mask. An object to be inspected is imaged and the position mask is drawn. A processor matches the position mask for the object with the reference mask to determine a position and/or defects of the object.

### RELATED APPLICATION

This application is based upon prior filed copending provisional application Serial No. 60/364,194 filed Mar. 13, 2002.

### FIELD OF THE INVENTION

This invention relates to the field of inspection systems and methods, and more particularly, this invention relates to orienting objects for packaging and determining defects of the objects.

### BACKGROUND OF THE INVENTION

Containers, beverage cans, bottles, and similar containers are often packaged as groups of cans or containers, such as seen with a common six-pack or twelve-pack. Many of the containers have wrap-around labels, indicia marks printed on the containers, or other printed or labeled trademark information. In some prior art packaging systems, the labels or printed indicia are not oriented, i.e., the labels or indicia do not face the same way in the six-pack, twelve-pack, or other container package. This is not advantageous because manufacturers and retailers want the containers to face one direction when on display in a retail establishment. One of the systems used in the prior art to overcome this problem is to repeat indicia on labels or on the container itself in the hope that when a number of containers are placed in the package, there will be a high probability that any indicia printed on the container or on a label will face in the proper direction and be visible by a consumer. One drawback of this prior art approach, however, is that repeating indicia took much space and did not leave much “real estate,” which should preferably be available for promotional indicia.

Not only is orientation and position determination necessary as noted above, but it would also be advantageous if defects could be determined during an inspection process that determines object position. Defect determination should also be capable of using color analysis in some cases to assist in determining defects on containers, such as beverage cans, which typically include a number of color indicia or labels that must be inspected. For example, mixed labels, misaligned labels and missing labels should be properly inspected. False accepts, such as accepted bad units, and false rejects, such as good units that are rejected, should be close to zero in a modern inspection process. Any inspection process should be applicable to different types of cylindrical, circular and spherical objects, such as but not limited to, beverage cans, food cans, can ends, PET bottles and many other cans, ends, and container or similar articles.

### SUMMARY OF THE INVENTION

The present invention advantageously provides a system for inspecting cylindrical, circular or spherical objects, such as containers and cans, which determines not only position for an object to be inspected, such as for orienting the object, but also determines defects. A label or printed indicia on any cylindrical, circular or spherical object can be inspected in-line. Customer orientation equipment is used with minimal user intervention to orient a container for packaging. Also, mixed labels, misaligned labels and missing labels and indicia on various objects, such as beverage and food cans, can be inspected and any objects rejected.

In accordance with the present invention, the system and method of the present invention inspects cylindrical, circular or spherical objects. A processing line conveys objects that are advanced for inspection. An inspection station is located at the processing line and has at least one camera for acquiring images of a reference object and objects to be inspected as the objects to be inspected advance along the processing line into the inspection station. An object rotator rotates a reference object at the inspection station.

The reference object is imaged by the at least one camera as it rotates into rotated positions. A processor is operatively connected to the at least one camera and object rotator and draws a position mask based on the images of the reference object in rotated positions to create a reference mask, which is stored. When an object advances into the inspection station, the camera acquires an image and the position is formed for an object. The position mask for the object is matched with the reference mask to determine a position and/or defects of the object.

In one aspect of the present invention, the processor is operative for matching by a convolution summing algorithm. The processor is also operative for establishing a confidence level after determining position of the object for determining a defective object.

A reject mechanism can be used for rejecting objects after determining that objects are defective. The position mask can be a line, a series of lines, an arbitrary pattern, or it can be drawn from a saved pattern.

In yet another aspect of the present invention, the rotator comprises a vertically movable object engaging member that extends to engage a reference object and rotate same on the processing line in a controlled manner. The objects could be cylindrical containers, such as cans. The object engaging member could include a rubber cone that engages a top of the can or container to rotate the container without damaging the container or can. A strobe light could be positioned at the inspection station for illuminating the reference object and later an object to be inspected for image acquisition. The strobe light would provide the same ambient light during image acquisition of both the reference object and an object to be inspected.

An object orientation mechanism can be located downstream of the inspection station for orienting an object after determining its position. The processing line can be formed as a vacuum conveyor that holds objects thereon while advancing them into the inspection station. The camera can comprise a color camera for obtaining red, green and blue (RGB) color values. The processor is operative for comparing RGB color values obtained on a position mask or large are a mask (blob analysis) for an object with RGB color values of the reference mask and determining object defects. The position mask in this case is not line or pixel based but preferably formed as a large geometric area covering at least a portion of the object and termed as “blob” analysis.

A method of the invention is also set forth.

### BRIEF DESCRIPTION OF THE DRAWINGS

Other objects, features and advantages of the present invention will become apparent from the detailed description of the invention which follows, when considered in light of the accompanying drawings in which:

FIG. 1 is an isometric view of the system of the present invention showing a conveyor for conveying objects to be inspected, and the inspection station, where an operator monitors and controls the inspection process, and a reject and orientation mechanism where objects are oriented and/or rejected.

FIG. 2A is an isometric view inside the inspection station of FIG. 1 and showing the object rotator and a portion of the conveyor.

FIG. 2B is a block diagram showing the overall system of the present invention.

FIG. 3 shows an example of a basic convolution equation that can be used as a convolution summing algorithm in the present invention.

FIGS. 4-6 are detailed examples from an Excel software program table showing a first column as a reference image or “signal” that is shifted down and the subsequent columns relative to a “snap” of an object image and its position mask as used for determining position (and/or defects) by means of a convolution summing algorithm.

FIG. 7 is a plotted “reference” column from the previous example.

FIGS. 8 and 9 are respective plotted columns 1 and 11 from the previous example.

FIG. 10 shows convolution sums for the 22nd shift and showing a large sum that corresponds to column 22 as shown in FIGS. 4-6.

FIG. 11 is a flow chart illustrating the steps used as an example for the reference creation.

FIG. 12 is a flow chart illustrating the steps used as an example for the comparison of the mask for an object to be inspected with the reference.

FIG. 13 is an example of a graph showing various segments for red, green and blue color values as used in the present invention.

FIG. 14 is an example of the type of user computer window that could be used for displaying on a computer screen as a user interface.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The present invention advantageously provides a system and method that identifies defects in cylindrical, circular or spherical objects and allows those objects to be oriented. The objects could be cans or other containers that are placed in a desired orientation for packaging. The system can build upon the artificial intelligence and algorithms as anomaly detection systems as disclosed in U.S. Pat. Nos. 6,519,356 and 6,525,333, both commonly assigned to Intelligent Machine Concepts, LLC, the disclosures which are incorporated by reference in their entirety.

The present invention creates a reference mask from a reference object, such as a beverage can, having the desired color and indicia or label. The present invention preferably uses an object rotator at an inspection station that rotates the reference object while in place on the processing line. At least one camera, and preferably a plurality of cameras, which could be grayscale but preferably color cameras, acquire images, and in the case of color cameras, individual red, green and blue (RGB) color values from images of the reference object as the reference object is rotated in rotated positions. A processor is operatively connected to at least one camera and object rotator, and a position mask is drawn based on images of the reference object in rotated positions to create a reference mask. In one aspect of the invention the position mask is a point or lines, or segments thereof. Larger areas can be selected for large area analysis (also termed “blob” analysis) for defect determination. It should be understood it may be possible to form a reference mask from a plurality of containers advancing along the line.

As objects are passed through the inspection station on the processing line, the camera(s) acquire an image and a position mask drawn for an object from the image. The position mask for the object to be inspected is matched with the reference mask to determine a position and/or defects of the object. This position mask can be a line or series of lines that can be broken into segments and/or large area masks for the “blob” analysis. The matching can be accomplished by convolution summing algorithms. Anomaly detection as set forth in the incorporated by reference '333 patent including the logic and artificial intelligence processing can be used with the present invention to determine defects and then reject containers.

It is possible to use a processor, such as a PC and memory, for a historical database and knowledge base for current and historical data and other defect data to be displayed on a graphical user interface or sent to a networked SPC system for off-line analysis.

It should be understood that the position mask (PM) can be used to determine the position of the object such as a can, container and/or other object. The mask preferably is also segmented and some color/grayscale analysis can be accomplished from mixed label and gross label defects. This system can also orient ends or tabs. For example, a pull tab on the ends of can be analyzed. Also, any printing located on the top of label could be analyzed. Instead of a linear or straight up and down position mask, it would be possible to use a circular position mask on the top of a can. For example, the system could draw radially around the top of the can. Thus, it is possible to orient round objects.

Intensity of color components can be stored for reference and all possible samples can be compared to the reference. Rejection criteria can be determined by the use of anomaly detection and rejection systems as disclosed in the incorporated by reference '356 and '333 patents.

The use of the term “blob” (BLOB) is selected for large area color (or grayscale) analysis and is a relative term. The “blobs” are typically larger geometric areas and not lines or segments similar to the linear or point related position mask as described above. It should be understood that the term position mask in accordance with the present invention is broad enough to encompass the term “blob” but the term large area mask refers to the larger area “blob” analysis. The color components can be determined and in the case of the reference they are stored. The samples are compared to the reference and rejection criteria as determined by the system and processes, including anomaly detection set forth in incorporated reference '356 and '333 patents. Other criteria can be used. Typically, the position mask is line or discreet point oriented and the larger area analysis or “blob” analysis as referred to herein is area oriented. The position mask, including large area “blob” analysis may span multiple cameras. The interface to the position mask and the “blob” can be made to fit a standard model of an anomaly detection system as disclosed in the incorporated by reference patents and other reject criteria can be established by those skilled in the art during system operation.

The line or discreet point orientation in a position mask is advantageous because the line can be drawn oblique to a can. Thus, during high speed processing where 50 or more cans move through the inspection station each second, even when a can moves up or down vertically because of vibration and high speed movement, it is still possible to have position mask oblique to the can and obtain a proper analysis orientation and “blob” analysis.

It should be understood that the position mask is unique at each scan position. This can be accomplished by comparing each position with itself and other positions. Each position could identify with itself as “better” than any other position. A value can be assigned to this difference and can be termed a Figure of Merit (FOM). This would be the ratio of the closest match of a position to another position. If this is 1 or greater the mask is not acceptable. For example, a mask Figure of Merit of 0.95 gives about a 5 percent noise margin.

In any “blob” comparisons, large area analyses are accomplished primarily with color components, i.e. red to red, green to green and blue to blue. The color components are generally used as fractions of the total color (the reference and sample are treated the same) similar to red/green/blue. Thus the sensitivity to intensity changes is minimized by this type of process. Cross ratios can be used to obtain an idea about intensity variations which is advantageous. If a can has much “dead” area, e.g. much red color, and no other identifying indicia, then that type of analysis would be advantageous.

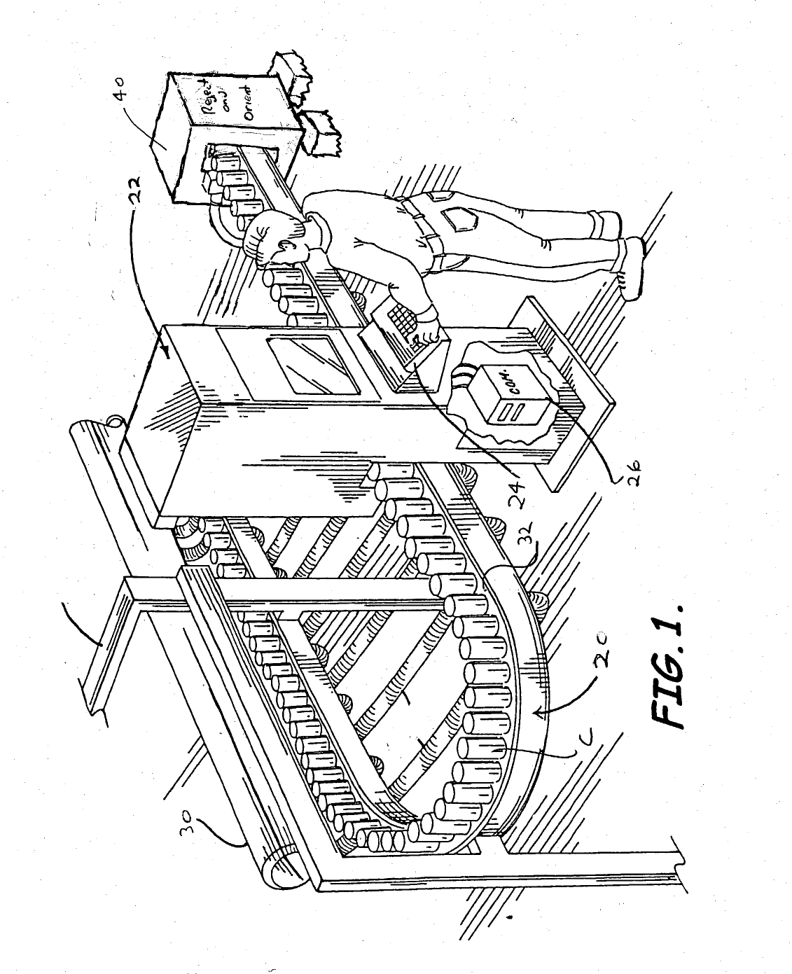

FIG. 1 shows an example of overall physical system components used in the system and method of the present invention. A conveyor 20 can hold objects, such as cans (labeled as “C” in the drawings), in a vertical orientation and adjacent to each other, such as touching each other. The cans could be separated by a star wheel assembly (not shown) to allow some separation. The cans are advanced along a predetermined path of travel defined by the processing line as the conveyor 20 into an inspection station generally designated at 22. Although the term “cans” is used throughout the description, other objects and containers could be used and could be formed in many different shapes, including cylindrical and other configurations with openings to be inspected by the system. Other objects, such as circular or spherical objects, could also be inspected by the present system.

The inspection station 22 could be a separate unit that mounts over the conveyor 20 and is bolted to a floor. An operator console 24, such as the illustrated keypad and/or touch screen, could be mounted on the inspection station 22 for operating and controlling the inspection process. The conveyor 20 is mounted on an appropriate frame and suspension. A processor 26, such as a personal computer or a preferred programmable logic controller (PLC), could be mounted exterior to the unit or within the unit, as illustrated.

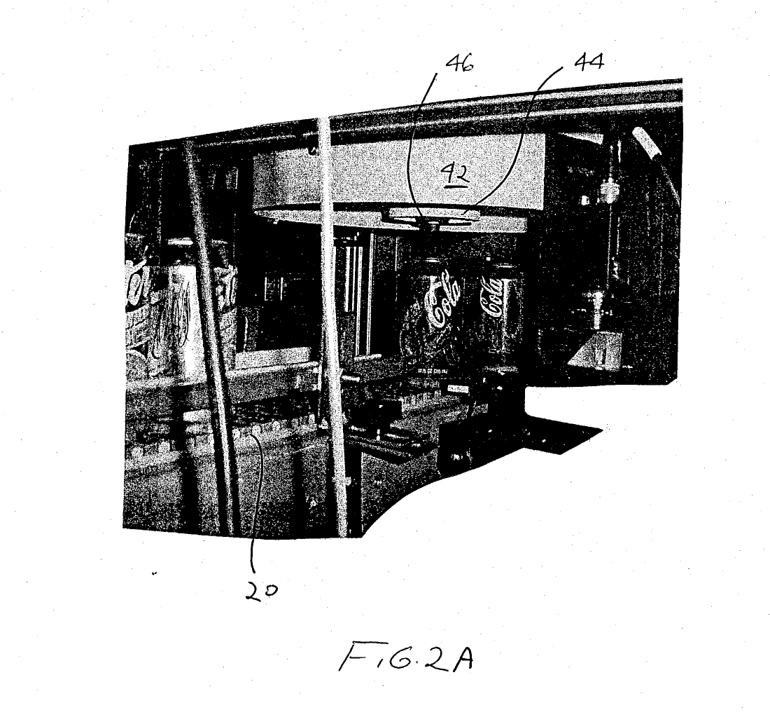

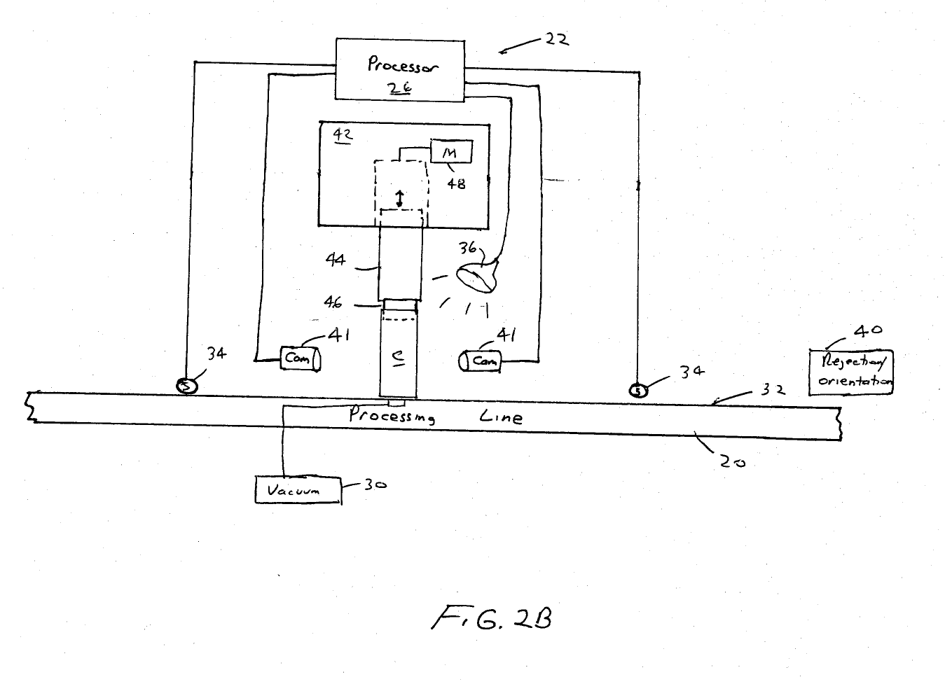

The conveyor 20 could include vacuum holes along various portions that connect to a vacuum system 30 to allow vacuum to be drawn from the top surface 32 of the conveyor to retain a can on the top surface. Various sensors 34 (FIG. 2B) can be used to indicate the presence of cans. The conveyor could be belt-driven to move the cans and vacuum could apply only minimal drawing force for stability only. Cans could also be advanced by pressure exerted from adjacent cans on a more stationary conveyor. In another conveyor system, air could also be forced upward against cans such that each can “floats” on a conveyor. The present system advantageously accommodates various movements of cans even when the cans are wobbling allowing correct orientation and defect analysis. It should be understood that different sensors 34 could be used, including through-beam sensors, which would allow the “open” or triangular area defined by adjacent bottom bevels of two cans to pass the through-beam sensor.

The inspection station 22 can include at least one light source 36 (FIG. 2B), such as a strobe light, for example a xenon strobe light. As will be explained in detail, the inspection station 22 is advantageous for determining not only the position of an object, such as the can (for orientation), but also determining defects, including color defect analysis. After inspection is accomplished at the inspection station, the cans can be oriented or rejected at the rejection/orientation station 40 (FIG. 1) where cans can be rotated into a desired orientation or rejected after they are determined to be defective, in accordance with the present invention. As described before, one or more cameras 41, including grayscale and color cameras, are positioned at the inspection station. It should be understood that the reference can can be an “average” colored can when any color analysis is important. A reference can or other object can be chosen that is typical for the average or “mean” label or printed indicia or coloring.

FIGS. 2A and 2B illustrate a rotator 42 that can be used in the present invention for rotating a reference object or can. The rotator has a vertically moveable object engaging member 44 and a rubber cone or other end portion 46 that can engage a can but not damage the can. The members 44, 46 rotate the can at a predetermined rate for image acquisition.

Although two cameras 41 are illustrated in FIG. 2B, it should be understood that one, two or more cameras including grayscale, color or a combination of both can be used for the present invention. It is not necessary that 100% coverage of a label or container be obtained, in accordance with the present invention. FIG. 2B shows that a stepper motor 48 can be attached to a rotator mechanism 42 and controlled by the processor 26 of the present invention.

In the present invention, an image is “snapped” of the container to be inspected and the system can draw a mask as a series of lines across the picture image corresponding to the label or printed indicia on a container. The system preferably draws lines across the label (or container) where the label (or container) has the most information, including text or other unique features. It should be understood that the position mask, in one aspect of the invention, can be used to determine the position of a can, container, and/or other object and can be segmented. It is possible to accomplish color/gray scale analysis for mixed label and gross label defects and the system, of course, can be used to orient ends or tabs.

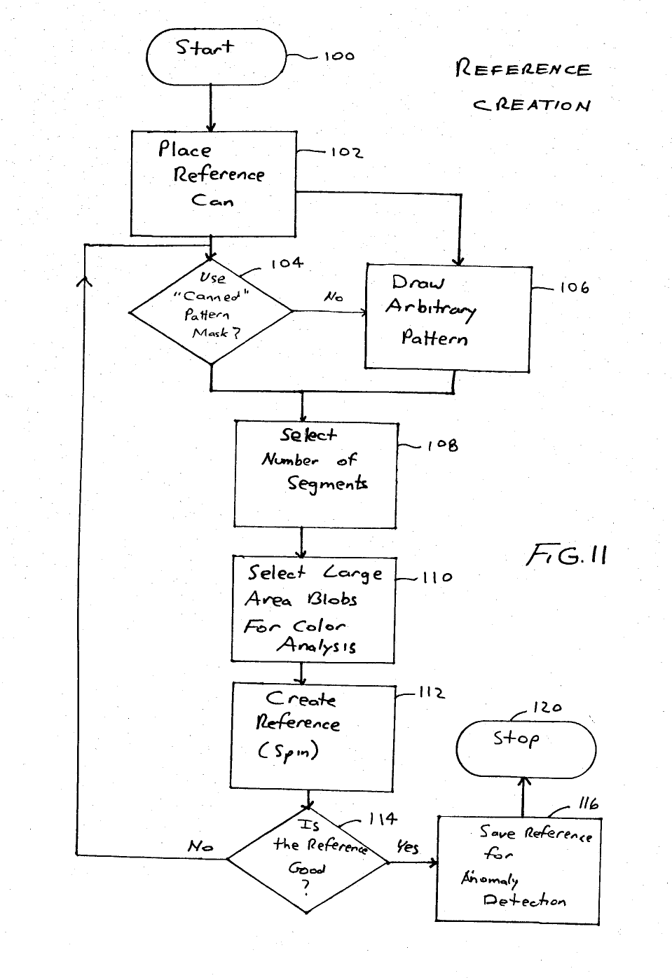

Referring now to FIG. 11, there is illustrated an example of some of the steps that can be used to create a reference. As shown in block 100, the process starts and at block 102 a reference can is placed at the inspection station. At this time, (block 104) a decision can be made whether to use a “canned” pattern mask or if a arbitrary pattern mask should be drawn (block 106). A canned pattern mask could include bars, small areas, lines, sinusoids, or exponential patterns either alone or in combination or in arrays. The arbitrary pattern mask may be desirable in order to concentrate on specific regions of a container or desirable if there is high amount of duplication on a label or can. For example, it may be desirable to concentrate on those portions that are not duplicated. One portion of a can could have milliliters or ounces printed thereon to help discern and orient the container.

At block 108 the number of segments is selected as a portion of a line for example. This could be accomplished for mixed label and gross defects. The smaller segments would allow greater sensitivity to smaller deviations because the system is looking at smaller areas. Larger areas tend to average out.

At block 110 larger areas are selected as large area “blobs” for color analysis. The system can be established for color or grayscale analysis. Again, smaller areas provide more sensitivity. For example, the entire length of a can could be chosen or the system would establish an area as wide as necessary as long as there is enough area chosen to accomplish analysis, even when the can wobbles during the high speed processing. This can be established for color RBG values or grayscale analysis using a monochrome camera as compared to color cameras. The smaller the large area analysis or “blobs”, the more sensitive. Defects can be better established with smaller areas but would increase processing power.

As shown at block 102, the references that are created by spinning the can and strobing if necessary or using ambient length depend on what is applied for lighting. The same criteria is applied to processing.

At block 114, the reference is checked to determine if it is acceptable. The position mask must be unique at each position and any color information should be free of reflection and stray light. It is possible to look at the reference visually or by the processor to establish a Figure of Merit (FOM). It is better to cross check all references in each position against the other references to ensure there is no ambiguity. This reference is then saved for anomaly detection at block 116 and the reference creation at block 118.

It should be noted that the reference creation process extracts and stores a reference mask for determination of position and can be accomplished for each step around the object as a position mask. It also extracts and stores larger areas for “blob” information. This can be considered as a mosaic of large areas on the object, typically rectangles, but could be other geometrically configured areas. The location and size, along with the color or grayscale information, are stored. The color and grayscale data are typically normalized for later comparison. For example, it is possible to compare the amount of red to the total RGB to obtain a ratio. As lighting changes, this type of comparison does not become as problematic for example, if the red color value diminishes. Other analysis may include frequency with sequence information and even wavelets.

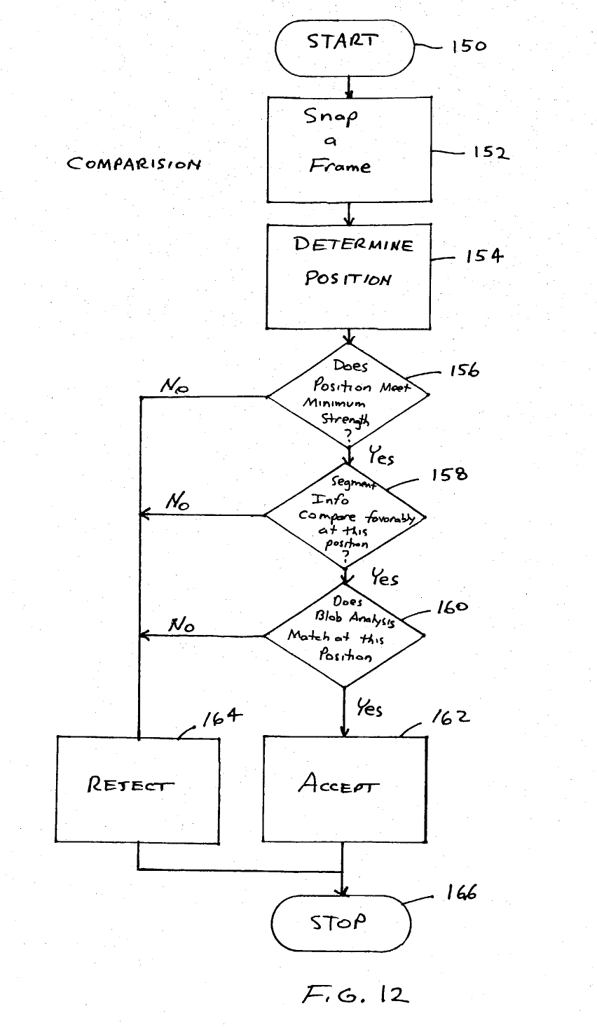

FIG. 12 shows an example of some of the steps that can be used in the comparison phase of the present invention. The process starts at block 150. An image or frame is snapped (block 152) and could be accomplished by one or multiple cameras as noted before. If multiple cameras are used, then the images could be concatenated and treated as one larger image. At block 154 the processor determines position and the convolution algorithm is used and guarantees a best position will always be found based upon the analysis. It may not be a good position in some cases, but it will be found. If a fairly low value is returned, for example, the position does not meet minimum strength (block 156) the system could consider a mixed label problem and a defect.

The anomaly detection processing could determine the criteria for the strength of position or the confidence. A decision is made whether the segment information compares favorably at this position (block 158). This segment information can include the position mask or its segments. It can include matching grayscale and matching color and individual analysis of the entire mask or its segment with respect to each other. If it does not compare favorably at this position, the system could consider a mixed label and a defect. This is a determination of whether the comparison is close. As to the segment choice, the system could choose the first 10 segments or could use all segments to determine position. For example, in areas where small print is located, the system could obtain a false indication that the label is bad and the processor could accommodate this information and data.

At block 160 the large area “blob” analysis is accomplished and the system determines whether it matches a position. This “blob” information is where most of the color comparison is accomplished. The intensity is matched with the reference by either using grayscale or color components with the red, green and blue color components. A cross comparison can be established at this position to look at other factors for defect analysis.

At this point if the “blob” analysis does not match at this position, then the system determines that color defect (or other defects) or mixed labels mandate that the can must be rejected (block 164). If the “blob” analysis does match at this position, then the can is accepted (block 162) and the process stops (block 166). Naturally, after “blob” analysis, other analysis can be accomplished for anomaly detection using existing data or new analysis tools can be incorporated. Other data could be added to the reference in the “snap”.

As an example of operation, the reference object or container could be spun in increments and the system processor via the image “grabs” the portion of a label underneath the mask that has been created. An image is created of everything that is based under the line. The reference is created as the container is slowly rotated. By the time the container or can is rotated 360 degrees, the image is created. For example, about 750 to about 900 lines could be used. Reference images can be assembled in the memory of the processor.

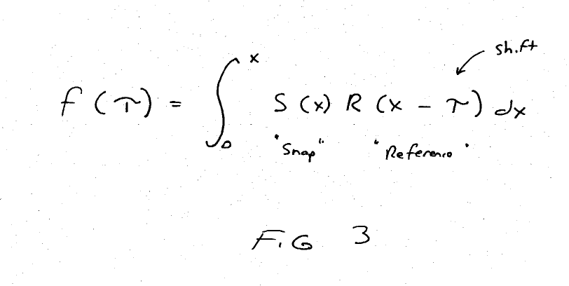

In system operation, cans or other containers with printed indicia or labels having artwork enter the inspection station having the camera 41 or a number of cameras. The cans or containers are moved forward along the predetermined path of travel in a random orientation into this inspection station 22. At that fixed point in space, where the references have been created, a picture image is “snapped” and the “scribble” based upon a position mask as a line or segment or whatever is accomplished. The line as snapped is processed through the reference image to define where there is a match using a convolution equation, such as shown in FIG. 3.

When there is a match, a peak occurs and the system determines how far to turn the container and orient the container in the required direction. A convolution equation, such as shown in FIG. 3 could be used in the present invention where R(x−τ)refers to the reference and S(x) refers to what has been snapped from the image. “τ” refers to the shift. The system integrates and possibly, as a second step, a derivative could be taken to determine slope, such that a small slope could correspond to many white areas and a steep slope could correspond to the image and indicia in the overlap for the peak.

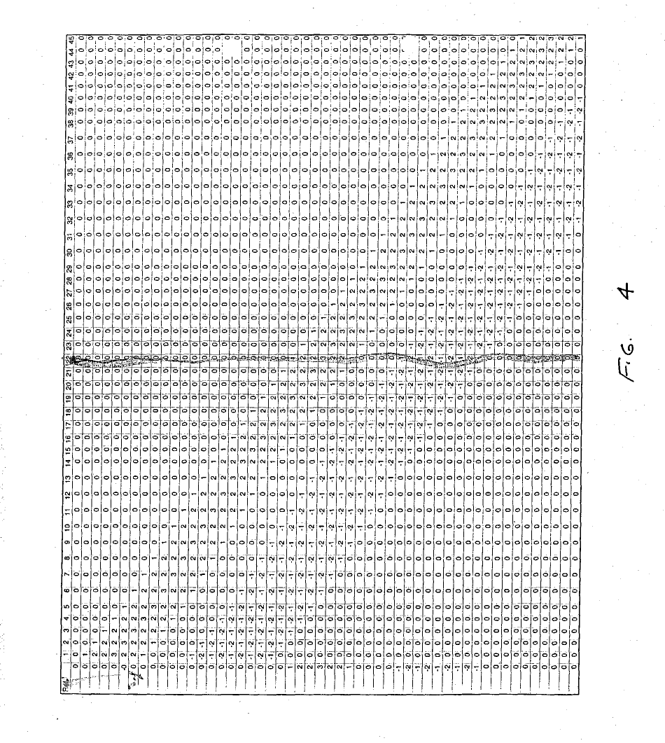

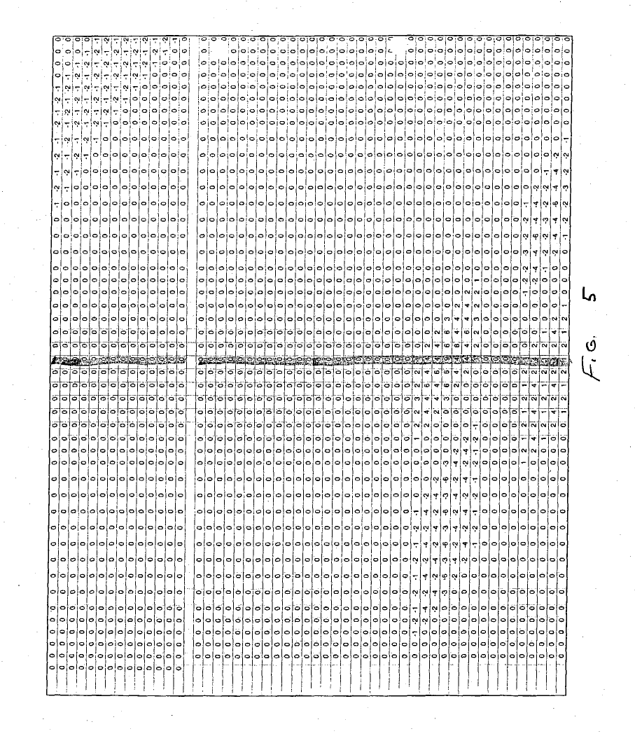

FIGS. 4 through 6 are detailed examples from an Excel software table, where the first column is a reference image for the “signal” and an example where the “signal” is shifted down to the beginning on the column labeled 1 and shifted down on subsequent columns.

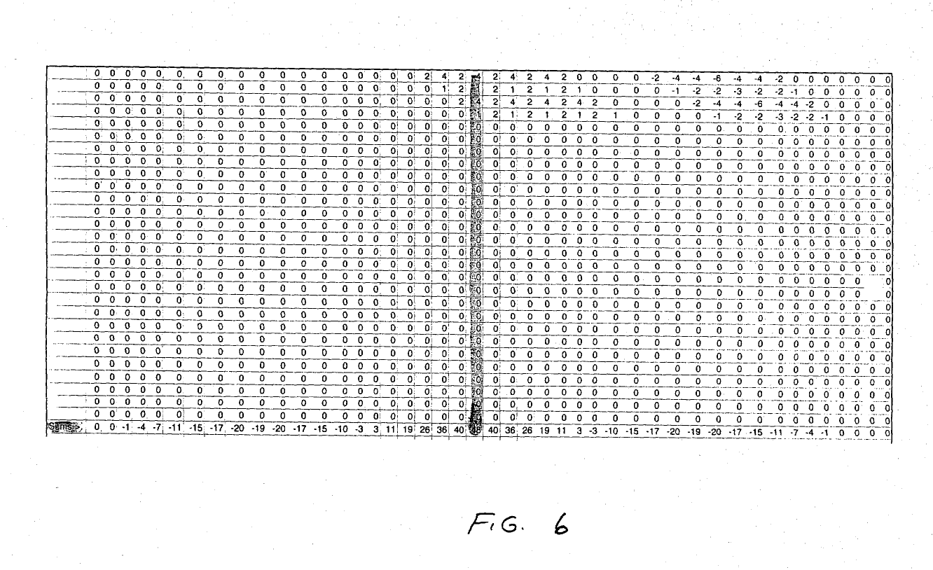

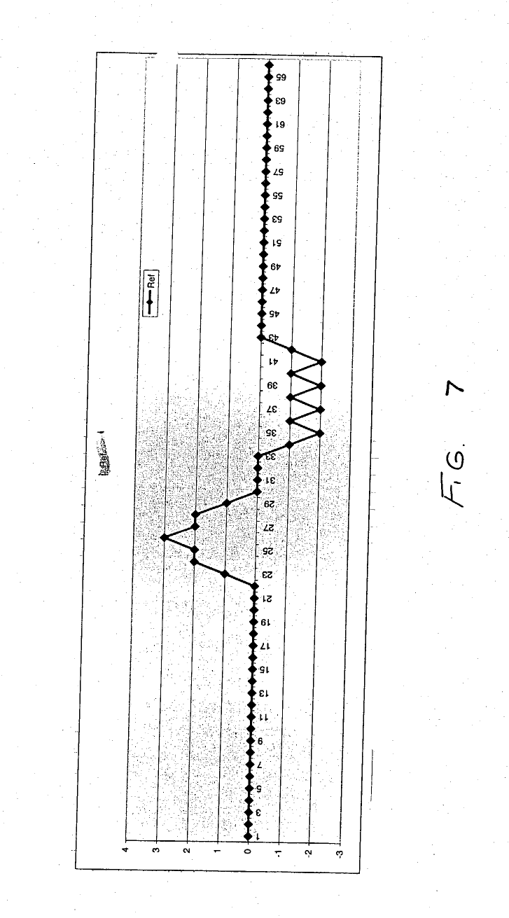

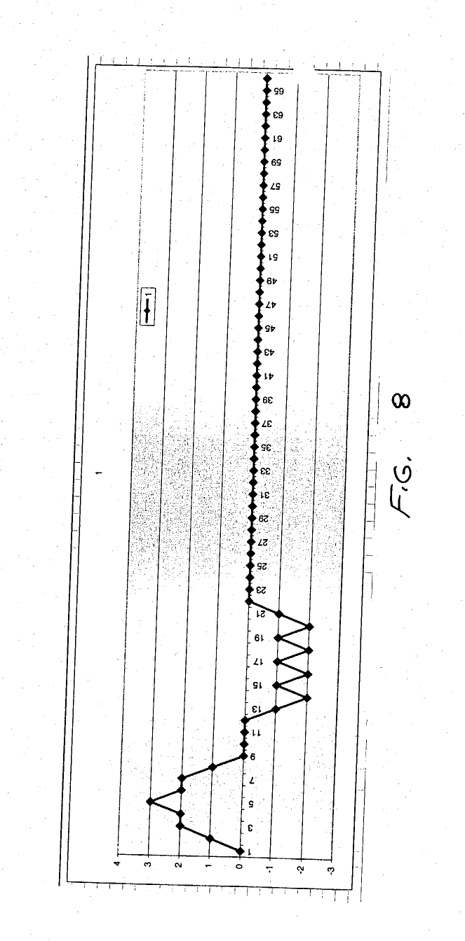

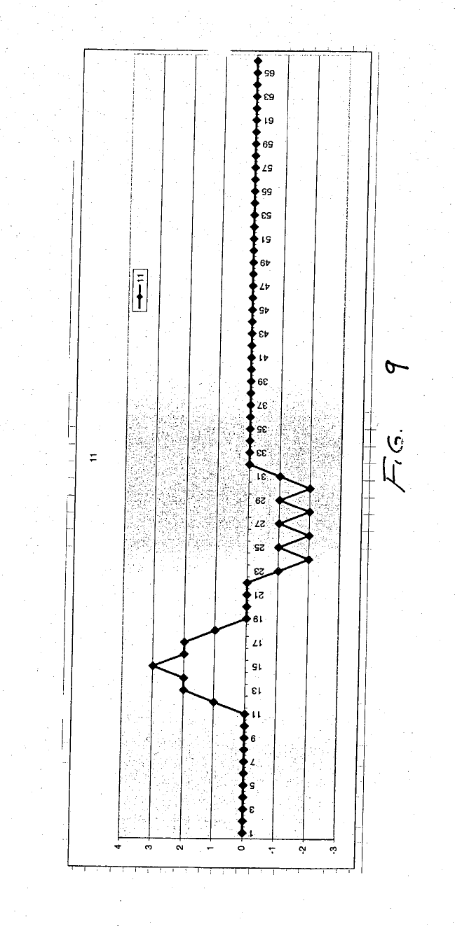

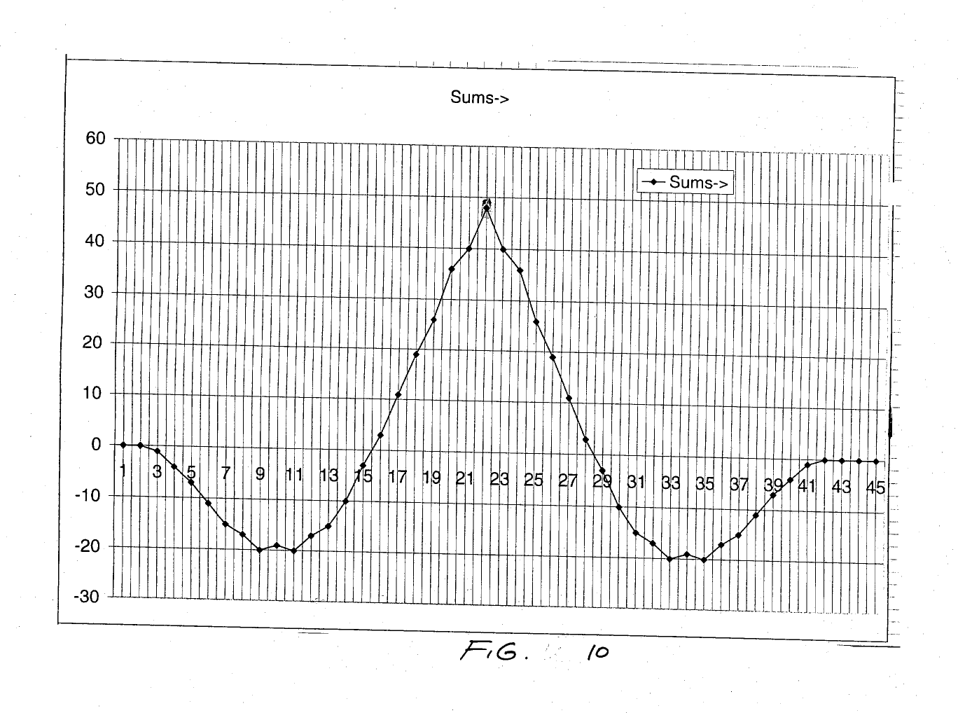

FIG. 7 is a plotted “reference” column and FIGS. 8 and 9 are plotted columns 1 and 11. The reference column is multiplied by the corresponding cell and the shifted “signal” in the numbered columns and products are summed for each individual numbered column. The convolution sums are in the row labeled sums in FIG. 6. As shown in FIG. 10, the 22nd shift produces the largest sum (48), which corresponds to the reference image sum shown in the table of FIG. 6.

The selection of a position mask could be automatic through appropriate selection of sensors or other means to determine what is the better mask. It is also possible to use two or more cameras instead of the one illustrated that could be spaced 90 degrees or 120 degrees apart. Two or more cameras may not add additional processing overhead because the two sides are two different areas of a container that could be imaged. It is also possible to use a prism with one camera to image two places on the label or can. It should be understood that every time an extra pixel is obtained, the number of computations required increases as a square. It is not a linear relationship. Improvements to processing systems such as disclosed in commonly assigned U.S. Pat. Nos. 6,327,520 and 6,259,519, which are hereby incorporated by reference in the invention can also be used.

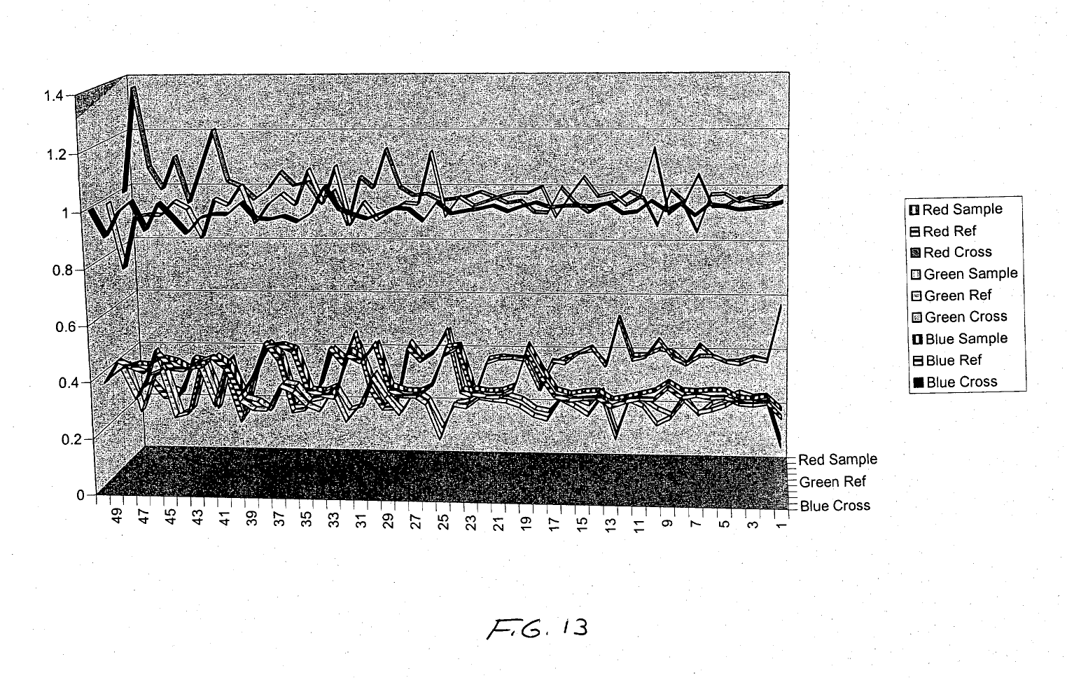

FIG. 13 is a graph illustrating a segment analysis and showing the red samples and references and red cross ratio and showing other green and blue samples, references and cross ratios.

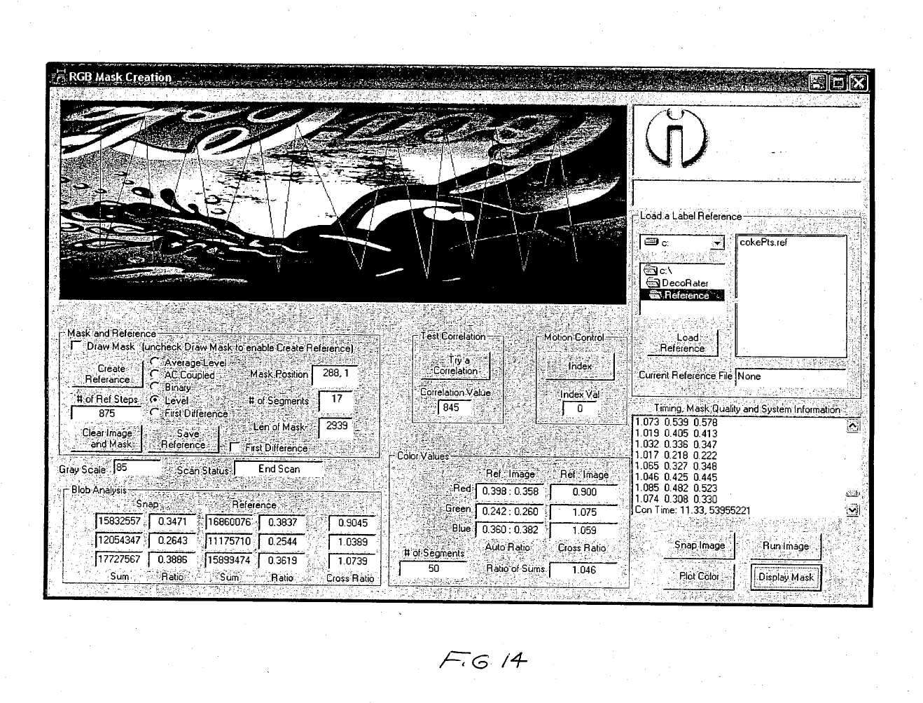

FIG. 14 is an example of an RGB mask creation window that could be used in the present invention for display and user interaction. This window shows the different “snap” and “reference” in the large area “blob” analysis (bottom left corner) and color values and reference image with the red, green and blue color values in the cross ratio. It also shows the number of segments and the number of reference steps with various data entry boxes and data indexes that can be chosen for the present invention. The upper left corner shows a mask with lines drawn in a position mask as a non-limiting example. The upper right corner shows a label reference that can be loaded for a Coke can.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that the modifications and embodiments are intended to be included within the scope of the dependent claims.

That which is claimed is:

1. A system for inspecting cylindrical, circular or spherical objects comprising:
a processing line on which objects are advanced for inspection;
an inspection station on the processing line and having at least one camera for acquiring images of a reference object and objects to be inspected as the objects advance along the processing line into the inspection station;
an object rotator at the inspection station for rotating a reference object at the inspection station, wherein the reference object is imaged by the at least one camera as it rotates into rotated positions; and
a processor operatively connected to the at least one camera and object rotator for drawing a position mask based on images of the reference object in rotated positions to create a reference mask and drawing the position mask for an object that has been imaged at the inspection station as it has advanced along the processing line and matching the position mask for the object with the reference mask to determine a position and/or defects of the object.

2. A system according to claim 1, wherein said processor is operative for matching by a convolution summing algorithm.

3. A system according to claim 1, wherein said processor is operative for establishing a confidence level after determining position of the object for determining a defective object.

4. A system according to claim 3, and further comprising a reject mechanism for rejecting objects after determining that objects are defective.

5. A system according to claim 1, wherein said processor is operative for drawing a position mask as a line, a series of lines, or an arbitrary pattern.

6. A system according to claim 1, wherein said processor is operative for drawing a position mask from a saved pattern.

7. A system according to claim 1, wherein said rotator comprises a vertically movable object engaging member that extends to engage a reference object and rotate same on the processing line in a controlled manner.

8. A system according to claim 1, wherein said objects comprise cylindrical containers.

9. A system according to claim 1, and further comprising a strobe light positioned at the inspection station for illuminating the reference object and an object to be inspected for image acquisition.

10. A system according to claim 1, and further comprising an object orientation mechanism located downstream of the inspection station for orienting objects after determining position.

11. A system according to claim 1, wherein said processing line comprises a vacuum conveyor that holds objects thereon while advancing them into the inspection station.

12. A system according to claim 1, wherein said camera comprises a color camera for obtaining red, green and blue (RGB) color values, wherein said processor is operative for comparing RGB color values obtained on a mask for an object with RGB color values of the reference mask to determine object defects.

13. A system according to claim 1, wherein said position mask comprises a geometric area covering at least a portion of the object.

14. A system inspecting cylindrical, circular or spherical objects comprising:
a processing line on which objects are advanced for inspection;
an inspection station on the processing line and having at least one color camera for acquiring images of a reference object and objects to be inspected that are advanced along the processing line into the inspection station including individual RGB color values;
an object rotator at the inspection station for rotating a reference object such that the reference object is imaged as it rotates into rotated positions; and
a processor operatively connected to the at least one camera and object rotator for drawing a large area mask in rotated positions as the reference object is rotated to create a large area reference mask based on individual RGB color values and drawing the large area mask for an object that has been imaged at the inspection station based on individual RGB color values and matching the large area mask for the object with the large area reference mask to determine a position and/or defects of the object.

15. A system according to claim 14, wherein said large area reference mask comprises a mosaic of masks.

16. A system according to claim 14, wherein said processor is operative for establishing a confidence level for determining a defective object.

17. A system according to claim 14, and further comprising a reject mechanism for rejecting objects after determining that objects are defective.

18. A system according to claim 14, wherein said rotator comprises a vertically movable object engaging member that extends to engage a reference object and rotate same on the processing line in a controlled manner.

19. A system according to claim 14, wherein said objects comprise cylindrical containers.

20. A system according to claim 14, and further comprising a strobe light positioned at the inspection station for illuminating an object for image acquisition.

21. A system according to claim 14, wherein said processor is operative for determining position of an object, and further comprising an object orientation mechanism located downstream of the inspection station for orienting objects after determining position.

22. A system according to claim 14, wherein said processing line comprises a vacuum conveyor that holds objects thereon while advancing them into the inspection station.

23. A method of inspecting cylindrical, circular or spherical objects that advance along a processing line comprising the steps of:
rotating a reference object on the processing line at an inspection station at the location where advancing objects are to be inspected, and while rotating the reference object, imaging the reference object and drawing a position mask based on the images at rotated positions as the object is rotated to create a reference mask;
advancing an object to be inspected along the processing line into the inspection station;
imaging the object and drawing the position mask for the object; and
matching the position mask for the object to be inspected with the reference mask to determine position and/or defects of the object.

24. A method according to claim 23, and further comprising the step of orienting the object after determining its position to place the object into a desired orientation.

25. A method according to claim 23, wherein the matching occurs by a convolution summing.

26. A method according to claim 23, and further comprising the step of establishing a confidence level after determining the position of the object for determining a defective object.

27. A method according to claim 23, and further comprising the step of drawing the position mask as a line or series of lines.

28. A method according to claim 23, and further comprising the step of drawing the position mask as an arbitrary pattern.

29. A method according to claim 23, and further comprising the step of drawing a position mask from a saved pattern.

30. A method according to claim 29, wherein the saved pattern for the position mask comprises one of bars, small areas on the object, lines, sinusoids, and exponentials, either alone or in combination with each other or in arrays.

31. A method according to claim 23, and further comprising the step of advancing objects along the processing line at the rate of at least 50 objects per second.

32. A method according to claim 23, and further comprising the step of selecting a number of segments of the position mask when creating the reference mask to allow greater sensitivity to smaller deviations.

33. A method according to claim 23, and further comprising the step of imaging and drawing a pattern mask for the reference and object as a mosaic of large geometric areas.

34. A method according to claim 23, wherein the mosaic of areas comprise rectangles.

35. A method according to claim 23, and further comprising the step of imaging with a color camera and obtaining separate red, green and blue (RGB) color values and comparing RGB color values for the object to be inspected with the RGB color values of the reference mask to determine in the defects in the object to be inspected.

36. A method of inspecting cylindrical, circular or spherical objects that advance along a processing line comprising the steps of:
rotating a reference object on the processing line at an inspection station where advancing objects are to be inspected and while rotating the reference object, imaging the reference object using at least one color camera and drawing a large area mask as the object is rotated in rotated positions to create a large area and a reference mask based on individual red, green and blue (RGB) color values;
advancing an object along the processing line into the inspection station and at the inspection station, imaging the object using the at least one color camera and drawing the large area mask for the object based on individual RGB color values; and
matching the large area mask for the object with the reference mask based on individual RGB color values to determine a position and/or defects of the object.

37. A method according to claim 36, wherein the large areas comprise rectangles.

38. A method according to claim 36, and further comprising the step of orienting the object after determining defects to place the object into a desired orientation.

39. A method according to claim 36, wherein the matching occurs by a convolution summing.

40. A method according to claim 36, and further comprising the step of establishing a confidence level after determining the position of the object to be inspected for determining a defective object.

41. A method according to claim 36, and further comprising the step of advancing objects to be inspected along the processing line at the rate of at least 50 objects per second.

42. A method of inspecting cylindrical, circular or spherical objects that advance along a processing line comprising the steps of:
individually imaging a plurality of objects advancing along the processing line and creating a reference mask from position masks based on images of the plurality of objects;
advancing an object to be inspected along the processing line and imaging the object to and drawing the position mask for the object; and
matching the position mask for the object to be inspected with the reference mask to determine the position and/or defects of the object.
